(19) United States
(12) Patent Application Publication
(10) Pub. No.: US 2013/0149893 A1
(43) Pub. Date: Jun. 13, 2013

(54) POWER ADAPTER CORD INCLUDING ROTATABLE CONNECTOR

(71) Applicant: INVUE SECURITY PRODUCTS INC., Charlotte, NC (US)

(72) Inventors: Robert Bisesti, Charlotte, NC (US); Phillip Stein, Waxhaw, NC (US); David N. Berglund, Charlotte, NC (US)

(73) Assignee: INVUE SECURITY PRODUCTS INC., Charlotte, NC (US)

(21) Appl. No.: 13/711,740

(22) Filed: Dec. 12, 2012

Related U.S. Application Data
(60) Provisional application No. 61/569,933, filed on Dec. 13, 2011.

(51) Int. Cl. H01R 13/72

(52) U.S. Cl. CPC H01R 13/72
USPC 439/502

(57) ABSTRACT

A power adapter cord for providing electrical power to an article of merchandise displayed on a merchandise display device includes a cable assembly containing at least one conductor and having a first connector at a first end for electrical connection to a power output port provided on the merchandise display device and a second connector at a second end for electrical connection to a directional power input port provided on the article of merchandise. The second connector includes a housing defining an internal compartment for a rotatable connector bobbin and a connector element secured to the connector bobbin such that the connector bobbin and the connector element are rotatable relative to the housing. A printed circuit board is mechanically connected to the connector element and is electrically connected between the connector element and the at least one conductor.

### CROSS REFERENCE TO RELATED APPLICATIONS

This non-provisional application claims the benefit of U.S. Provisional Application No. 61/569,933, filed on Dec. 13, 2011.

### FIELD OF THE INVENTION

This invention relates generally to merchandise display systems and devices for providing power to an article of merchandise. More particularly, the invention is a power adapter cord including a rotatable connector for providing power to an article of merchandise that is attached to a merchandise display device. The power adapter cord has a first connector at a first end configured to be electrically connected to a merchandise display device in a predetermined orientation and a rotatable second connector at a second end configured to be electrically connected to an article of merchandise in different orientations.

### BACKGROUND OF THE INVENTION

Retailers routinely exhibit electronic articles of merchandise, such as mobile (e.g. cellular) telephones, digital music players, game consoles, personal data assistants (PDAs), digital cameras, DSLRs, laptop computers, tablets and the like, for customers to examine before making a purchase. Retailers often desire the article of merchandise to be powered so that the customer can also evaluate the operation of the merchandise. At the same time, the retailer does not want the article of merchandise to be stolen or removed from the display area by an unauthorized person. Accordingly, the article of merchandise is attached to a merchandise display device that monitors and protects the article of merchandise from theft or removal. The merchandise display device typically includes a sensor that is operatively coupled to the article of merchandise and electrically connected to sensor electronics for monitoring whether the article of merchandise remains securely attached to the merchandise security device. In the event that the article of merchandise is detached from the merchandise security device, an audible or visible alarm is activated to alert store personnel of a possible theft situation. The merchandise display device may also include power electronics, such as a transformer, voltage regulator, or the like, for providing an appropriate level of power to operate the article of merchandise while being displayed on the merchandise display device at the retail display.

As such, merchandise display devices for displaying, protecting and powering an article of merchandise are known. It is also known to provide a power adapter cord for electrically connecting the power electronics of the merchandise display device to the article of merchandise. More specifically, the power electronics are electrically coupled to a power output port of the merchandise display device, and a power adapter cord is supplied to electrically connect the power output port of the device to a power input port on the article of merchandise. Typically, the power adapter cord has a preselected connector at one end that connects to the power output port of the merchandise display device. Different articles of merchandise, however, require different types of connectors at the other end of the power adapter cord to connect to the particular type of power input port provided on the article of merchandise. In addition, articles of merchandise that accept the same type of connector often position the power input port in different orientations. As a result, power adapter cords having a preselected type of connector at one end and different types of connectors at the other end in different orientations must be manufactured, inventoried and installed on the same merchandise display device depending on the particular article of merchandise to be displayed.

As used herein, the term “power adapter cord” is intended to include any cable, cord or adapter (also commonly referred to as a “pigtail”) containing one or more conductors for providing electrical power to an article of merchandise from an external source of power, including a merchandise display device having power electronics. The power adapter cord functions to power the article of merchandise, or alternatively, to charge an internal battery of the article of merchandise, in the absence of an external power source. As previously mentioned, the power adapter cord typically has a preselected type of connector at one end configured to be mated with a male plug or a female jack provided on the merchandise display device, and a specific type of connector at the other end configured to be mated with a directional male plug or female jack provided on the article of merchandise. As used herein, the term “directional” is intended to mean that the male plug or female jack provided on the article of merchandise requires an asymmetrical connector on the power adapter cord to be connected, or coupled, to the plug or jack in a predetermined orientation. In the exemplary embodiments shown and described herein, the directional male plug or female jack provided on the article of merchandise is a micro-USB plug or micro-USB jack that is positioned on the article of merchandise in different orientations. However, the directional connector of a power adapter cord according to the invention is not limited to a micro-USB type connector, and conversely, any type of directional connector configured to operatively engage a directional power input port of an article of merchandise suitable for display on a merchandise display device having power electronics and a power adapter cord is intended to be encompassed by the invention.

Accordingly, there exists a need for a power adapter cord for use with a merchandise display device to display articles of merchandise having a directional power input port that may be positioned in different orientations on the article of merchandise. There exists a further, and more specific, need for a power adapter cord having a first connector at one end configured to be electrically connected to a power output port of a merchandise display device and a second connector at the other end configured to operatively engage a directional power input port positioned on an article of merchandise in different orientations. There exists a particular need for a power adapter cord having a preselected type of connector on a first end that is configured to be electrically connected to a source of electrical power and an asymmetrical connector on a second end that is configured to operatively engage and to be electrically connected to a power input port positioned on an article of merchandise in different orientations.

### BRIEF DESCRIPTION OF THE DRAWINGS

FIG. 1 is a side perspective view of a merchandise display device for displaying an electronic article of merchandise that is powered by a power adapter cord according to the invention.

FIG. 2 is a rear perspective view of the merchandise display device of FIG. 1 including the power adapter cord.

FIG. 3 is a perspective view of an exemplary embodiment of a power adapter cord according to the invention in an assembled configuration.

FIG. 4 is an exploded perspective view of the power adapter cord of FIG. 3 in an unassembled configuration to show the various components of the power adapter cord in greater detail.

### DETAILED DESCRIPTION OF EXEMPLARY EMBODIMENTS

The accompanying drawing figures, wherein like reference numerals denote like elements throughout the various views, show one or more exemplary embodiments of a power adapter cord according to the invention for powering an electronic article of merchandise, for example, a cellular telephone configured for display on a merchandise display device. In the exemplary embodiments, a power adapter cord, indicated generally by reference character 20, is electrically connected to a merchandise display device, indicated generally by reference character 10, to provide electrical power to an electronic article of merchandise, indicated generally by reference character M, while being displayed on the merchandise display device, for example at the display area of a retail store. However, the present invention is equally applicable to any power adapter cord configured to provide electrical power to any article of merchandise, item, product or the like, from an external source of power, regardless of whether the article of merchandise is attached to, coupled to, associated with or displayed on a merchandise display device in any location for any purpose. In other words, a power adapter cord 20 according to the present invention may be used in conjunction with any device, or alternatively, may be used alone, to electrically connect an article of merchandise M to an external source of power. A primary objective of the present invention is to provide a power adapter cord 20 configured for use with articles of merchandise M having a directional power input port positioned on the article of merchandise in different orientations, as will be described.

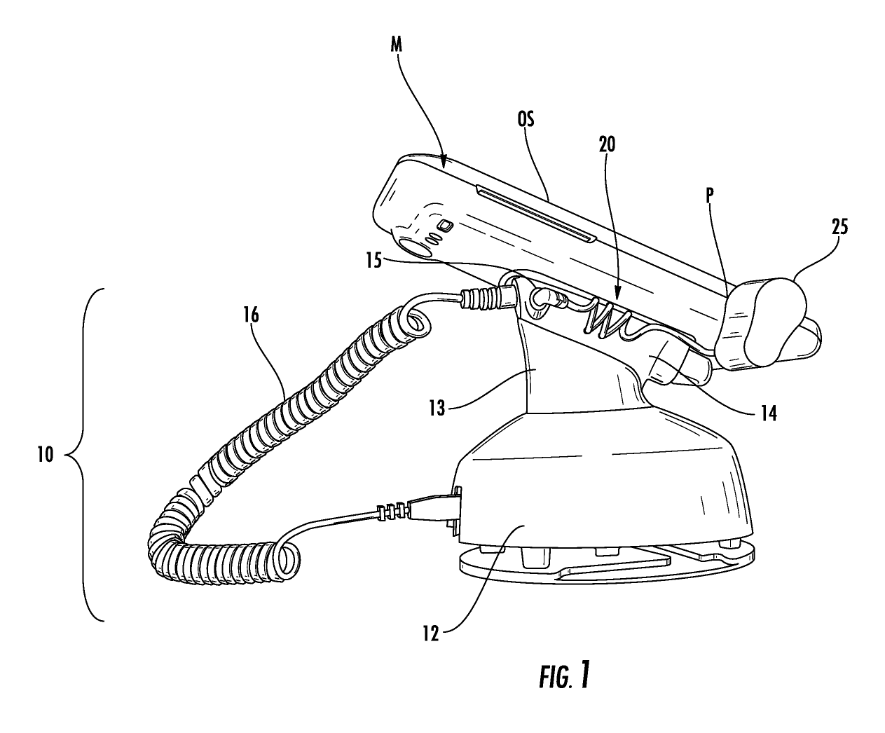

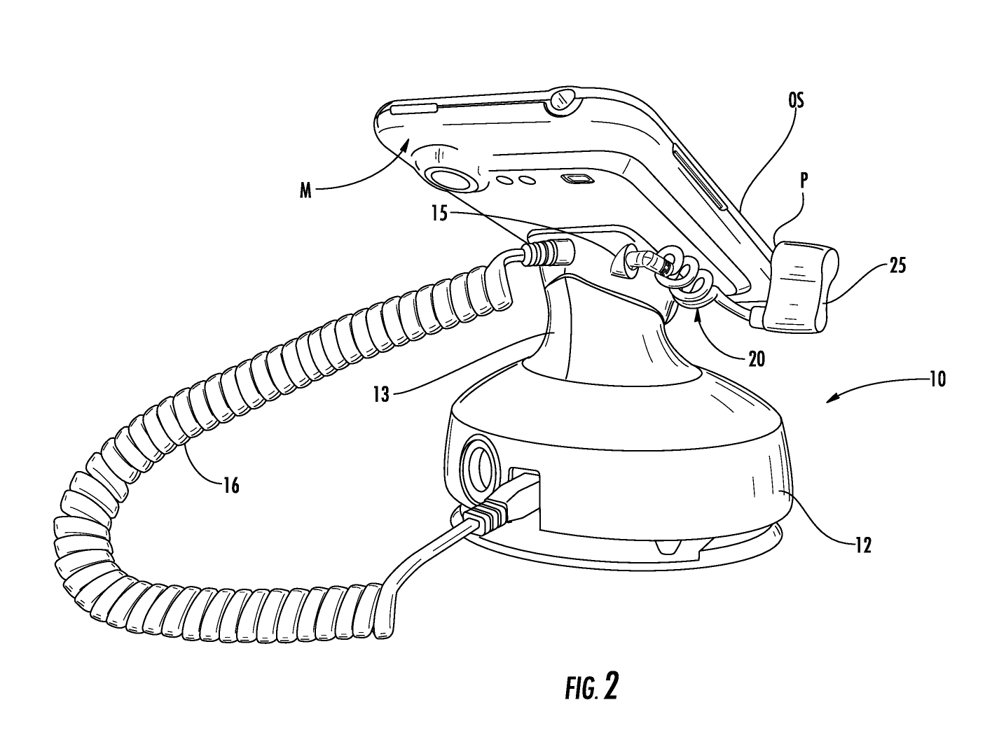

The exemplary embodiment of the invention shown in FIG. 1 and FIG. 2 is a merchandise display device 10 for displaying an electronic article of merchandise M, and further, for protecting the article of merchandise from theft or removal from a display area in a retail store. Typically, the merchandise display device 10 includes one or more sensors for determining whether the article of merchandise M remains attached to the merchandise display device, and sensor electronics for monitoring the state of the sensor(s) and for activating an alarm to alert store personnel to a possible theft or removal. However, for purposes of the present invention it is not necessary that the merchandise display device 10 include a sensor and sensor electronics to protect the article of merchandise M from theft or removal. By way of illustration only, the merchandise display device shown and described herein is a merchandise display stand 10 comprising a base 12 configured to house sensor electronics disposed within the base for monitoring the state of at least one sensor 14 that is removably supported on the base and configured for attachment to the article of merchandise M. As shown, base 12 may include an upwardly extending pedestal portion 13 for positioning the sensor 14, and consequently, the article of merchandise M, at a desirable elevation above a display surface, for example a counter, shelf, rack, table or the like. The article of merchandise M displayed on merchandise display stand 10 may be an electronic article of merchandise, for example a mobile (e.g. cellular) telephone, media player, game console, personal data assistant (PDA), digital camera, DSLR, laptop computer, tablet or the like, that requires electrical power for a potential purchaser to examine and to operate the article of merchandise before making a decision whether to purchase the item.

As illustrated in FIG. 1 and FIG. 2, the article of merchandise M is a conventional cellular type mobile telephone having a power input port P for receiving a power cable from an external source of power, such as an AC/DC transformer, commonly referred to as a “charger,” configured to be electrically connected to a standard alternating current (AC) power outlet. The power cable has a power plug at one end configured for connection to the power outlet and a specific type of connector at the other end configured for electrical connection to the power input port P of the article of merchandise M. In a common example, the power input port P is an asymmetrical female jack adapted to receive a corresponding asymmetrical male plug, such as a conventional micro-USB jack and plug. It is common for manufacturers of electronic articles of merchandise to position an asymmetrical power input port P (e.g. a micro-USB jack) in different orientations on the article of merchandise relative to an operating surface OS, such as a keyboard or display screen. For example, the asymmetrical (i.e. directional) micro-USB jack may be oriented parallel to the operating surface OS in either an upward-facing or downward-facing direction. Alternatively, the asymmetrical micro-USB jack may be oriented perpendicular to the operating surface OS in a left-facing or right-facing direction.

In most circumstances, the orientation of the directional power input port P is inconsequential since the power cord can be routed in a suitable direction away from the article of merchandise so as not to interfere with the operation of the article of merchandise M. However, the power adapter cord 20 of the present invention is utilized while the article of merchandise M is being displayed on the merchandise display stand 10 and retailers desire to maintain the article of merchandise M in a preferred viewing orientation relative to the merchandise display stand 10 while minimizing any obstructions to the operating surface OS of the merchandise. As a result, the power adapter cord 20 must be routed away from the article of merchandise in an aesthetic manner that does not interfere with the operation of the article of merchandise M. In particular, the power adapter cord 20 must extend between and electrically connect the power input port P of the article of merchandise M to the merchandise display stand 10 without interfering with the ability of a potential purchaser to examine and operate the article of merchandise. In addition, the power adapter cord 20 should not be bent, kinked or twisted excessively when routed from the merchandise security stand 10 to the power input port P of the article of merchandise to prevent mechanical damage to the power adapter cord and/or electrical damage to the article of merchandise as a result of an electrical short in the power adapter cord.

In the exemplary embodiments shown and described herein, the article of merchandise M is attached to the sensor 14 of the merchandise display stand 10 in a predetermined position and the sensor is removably supported on the pedestal portion 13 of the base 12 with the article of merchandise in a desired viewing orientation. The sensor 14 is mechanically and electrically connected to the base 12 by a sensor cord 16 that extends between the base and the sensor. As shown, sensor cord 16 is routed externally from the base 12 to the sensor 14. Alternatively, the sensor cord 16 may be routed from the base 12 internally through a central opening in the pedestal portion 13 to the sensor 14 so as to obscure the sensor cord from view while the sensor is supported on the base. Regardless, sensor cord 16 functions to electrically connect power electronics and monitoring electronics disposed within the base 12 with corresponding power electronics and sensor electronics disposed within the sensor 14. As previously mentioned, the power electronics of the merchandise display stand 10 may comprise a transformer, voltage regulator, or the like, along with any associated electronics disposed on a printed circuit board (PCB) for providing an appropriate level of power to operate the article of merchandise M at the retail display. Regardless, the power electronics of the sensor 14 are electrically coupled to a power output port 15 provided on the exterior of the sensor, for example a conventional barrel style connector jack for receiving a corresponding barrel style connector plug.

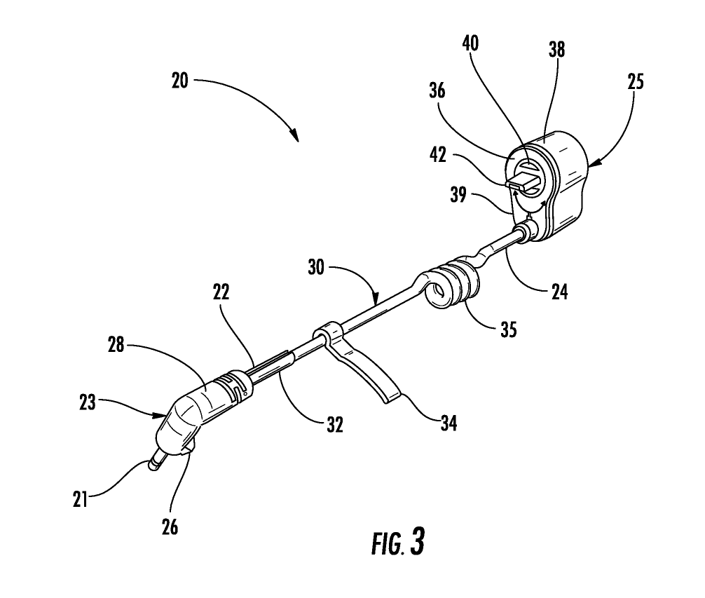

As best shown in FIG. 3, the power adapter cord 20 has a first end 22 provided with a first connector 23 configured to be received within the power output port 15 on the sensor 14, and a second end 24 provided with a second connector 25 configured to be received within the directional power input port P provided on the article of merchandise M. As shown herein, first connector 23 is a conventional barrel style connector 21. Barrel style connector 21 typically is omni-directional, and therefore, can be received within the power output port 15 of the sensor 14 in any desired orientation. However, first connector 23 may be provided with a retaining lip 26 for engaging a corresponding retaining groove (not shown) on the sensor 14 to retain the power adapter cord 20 on the sensor, as described in commonly owned and co-pending U.S. application Ser. No. 13/294,350 entitled MERCHANDISE DISPLAY SECURITY DEVICE INCLUDING MEANS FOR RETAINING POWER ADAPTER CORD, the disclosure of which is incorporated herein by reference in its entirety. Furthermore, first connector 23 may comprise a directional over-molded strain relief 28. Either of these features, as well as others, may cause the cable assembly 30 of the power adapter cord 20 to extend away from the power output port 15 of the sensor 14 in a predetermined direction. In the exemplary embodiment shown in FIG. 1 and FIG. 2, the combination of the retaining lip 26 and the directional over-molded strain relief 28 cause the cable assembly 30 of the power adapter cord 20 to extend away from the power output port 15 substantially parallel to the article of merchandise M in the direction of the power input port P.

As shown herein, second connector 25 at the second end 24 of the power adapter cord 20 comprises a micro-USB plug configured to be received within a directional micro-USB jack (not shown) at the power input port P on the article of merchandise M. As previously mentioned, the micro-USB jack at the power input port P may be positioned on the article of merchandise M in different orientations. However, it is desirable to route the cable assembly 30 of the power adapter cord 20 away from the power input port P on the article of merchandise M so as to conceal the power adapter cord with the sensor 14 beneath the article of merchandise removably supported on the base 12 (or on pedestal portion 13) of the merchandise display device 10. In this manner, the power adapter cord 20 will not interfere with the ability of a potential purchaser to view or access the operating surface OS of the article of merchandise M. As a result, the presence of the power adapter cord 20 will not adversely influence the decision whether to purchase the item. Furthermore, the display of the article of merchandise M on the merchandise display device 10 is more aesthetically pleasing to a potential purchaser when the portion of the power adapter cord 20 extending between the power input port P on the article of merchandise and the power output port 15 on the sensor 14 is concealed from view. As previously mentioned, cable assembly 30 of the power adapter cord 20 extends away from the power output port 15 on sensor 14 in a predetermined direction. Depending on the orientation of the power input port P on the article of merchandise M, a conventional power adapter cord may have to be bent, kinked or twisted excessively to insert the micro USB-plug into the directional micro-USB jack at the power input port P. In other instances, a conventional power adapter cord may have to be routed in a manner that interferes with the ability of a customer to view and/or access the operating surface OS of the article of merchandise M.

The power adapter cord 20 of the present invention is useable with articles of merchandise M having an asymmetrical (i.e. directional) power input port P positioned on the article of merchandise in different orientations. More specifically, the power adapter cord 20 includes a first connector 23 at a first end 22 and an asymmetrical second connector 25 at a second end 24 that is rotatable relative to the remainder of the power adapter cord. Preferably, the second connector 25 is rotatable through an angle of at least about one hundred eighty degrees (180°). As such, the rotatable second connector 25 may be electrically connected to articles of merchandise M having a corresponding directional power input port P positioned on the article of merchandise in different orientations. For example, a rotatable micro-USB plug on the second connector 25 at the second end 24 of the power adapter cord 20 may be electrically connected to a micro-USB jack provided on an article of merchandise M at a power input port P that is oriented in an upward-facing direction as well as in a downward-facing direction. Similarly, a rotatable micro-USB plug on the second connector 25 may be electrically connected to a micro-USB jack provided on an article of merchandise M at a power input port P that is oriented in a left-facing direction as well as a right-facing direction. As will be readily apparent to those skilled in the art, a second connector 25 having a rotatable micro-USB plug may be electrically coupled to a micro-USB jack positioned on an article of merchandise M in any number of different orientations such that the power adapter cord 20 is substantially concealed from view and does not interfere with operation of the article of merchandise. It will also be readily apparent to those skilled in the art that the same objective could be accomplished by providing a first connector 23 having a rotatable connector (e.g. plug) at the first end 22 of the power adapter cord 20 instead of, or alternatively, in addition to, the rotatable connector of the second connector 25 at the second end 24 of the power adapter cord.

Although a micro-USB plug and a corresponding micro-USB jack are shown and described herein with respect to second connector 25 and power input port P, respectively, the present invention is intended to be construed broadly to include any known type of connector interface, standardized or customized, and omni-directional or directional. Furthermore, if desired, power input port P may comprise a plug style connector and second connector 25 at second end 24 of power adapter cord 20 may comprise a jack style connector. In addition, as previously mentioned, first connector 23 at first end 22 of power adapter cord 20 may comprise a rotatable connector in addition to, or in place of, the rotatable connector at second connector 25. It is only necessary that the power adapter cord 20 has an appropriate first connector 23 at first end 22 to electrically connect conductors disposed within the power adapter cord to the power output port 15 on the sensor 14 and an appropriate second connector 25 at second end 24 to electrically connect the conductors to the article of merchandise M to be displayed on the merchandise display stand 10 wherein at least one of the connectors 23, 25 is movable relative to the remainder of the power adapter cord through an angle of at least about one hundred eighty degrees (180°) so that the power adapter cord may be routed between the sensor and the article of merchandise in a substantially concealed manner.

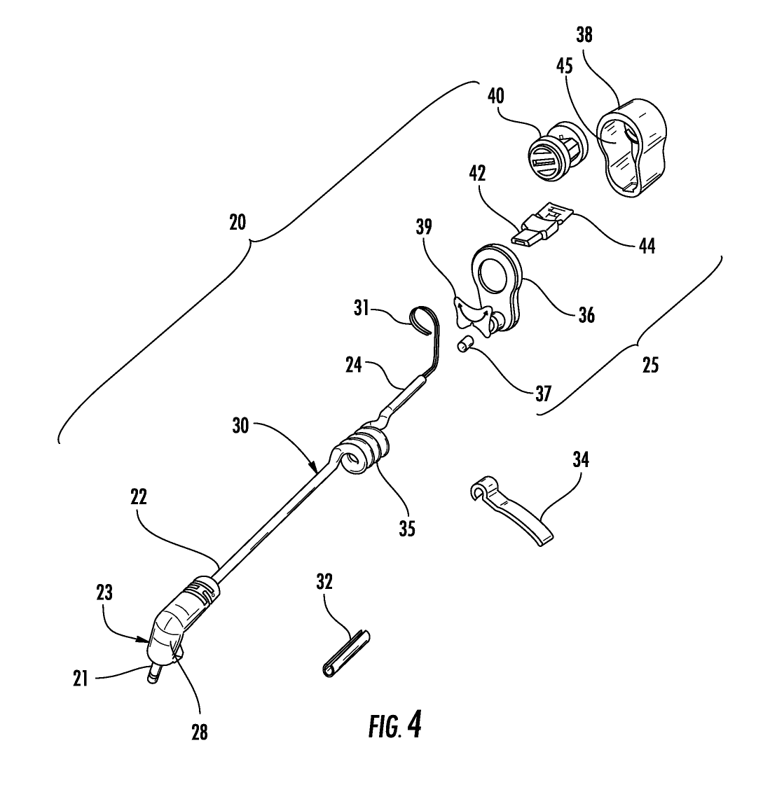

As shown in FIG. 3 and FIG. 4, the power adapter cord 20 comprises an elongate cable assembly 30 having first connector 23 at first end 22 and second connector 25 at second end 24. Cable assembly 30 comprises at least one, and preferably, at least a pair of conductors 31 (FIG. 4) for conducting power from the power electronics of the sensor 14 to the power electronics of the article of merchandise M in a conventional manner. As previously mentioned, first connector 23 is a conventional barrel style connector including a retaining lip 26 and an L-shaped, over-molded strain relief 28. The retaining lip 26 functions to retain the first connector 23 within the power output port 15 provided on the sensor 14 and the over-molded strain relief 28 permits the cable assembly 30 to extend away from the power output port in a direction that is substantially parallel to the article of merchandise. As shown herein, an optional label 32 containing, for example, part number and/or order code information, may be applied circumferentially about the cable assembly 30 adjacent the first connector 23. Also as shown herein, an optional cable management clip 34 may be disposed on the cable assembly 30 medially between the first end 22 and the second end 24 for guiding and/or securing the cable assembly to the sensor 14. One or more helical coils 35 may be formed from at least a portion of the cable assembly 30 to provide for a desired amount of elastic linear extension of the cable assembly from its static length and for biasing the length of the cable assembly to its static length.

The second connector 25 at the second end 24 of the cable assembly 30 comprises a front housing 36 and a rear housing 38 that are coupled together, for example by ultrasonic welding, to define a generally hollow interior compartment 45. A connector bobbin 40 is rotatably disposed within the interior compartment 45. Connector bobbin 40 is configured to securely retain a connector element 42, which in the exemplary embodiment is a micro-USB plug connector, and a printed circuit board (PCB) 44 that is electrically connected to the connector element. Connector element 42 may be secured to connector bobbin 40 in any suitable manner, such as by an adhesive or by an interference (press) fit. PCB 44 is attached to connector element 42 in a conventional manner typically specified by the connector manufacturer. As shown in FIG. 4, the conductor(s) 31 disposed within cable assembly 30 are passed through front housing 36 and a slot formed in connector bobbin 40 before being terminated on the PCB 44 in a conventional manner. As a result, first connector 23 is in electrical communication with the connector element 42 of the second connector 25 through the conductors 31 of cable assembly 30 and PCB 44. A crimp 37 may be provided as necessary to strain relieve the outer sheath of cable assembly 30 to the front housing 36 of the second connector 25. Furthermore, an indicator label 39 bearing indicia thereon may be affixed to the front housing 36 for indicating the direction and/or range of rotation of the connector element 42 secured to bobbin 40, for example one hundred eighty degrees (180°) about a longitudinal axis of the bobbin. It should be noted that conductor(s) 31 are provided with sufficient slack between crimp 37 and PCB 44 to permit bobbin 40 to be rotated throughout the entire desired range of rotation.

In use, the first connector 23 of the fully assembled power adapter cord 20 is inserted into the power output port 15 of the sensor 14. In the embodiment shown and described herein, the barrel style connector element 21 is inserted into the power output port 15. The first connector 23 is then rotated about the longitudinal axis of the connector element 21 so that the retaining lip 26 engages a retaining groove formed on the sensor 14 as described in the previously mentioned commonly owned and co-pending U.S. application Ser. No. 13/294,350. The retaining lip 26 and retaining groove secure the first connector 23 on the sensor 14 once the article of merchandise M is attached to the sensor. With the first connector 23 secured on the sensor 14, the cable assembly 30 extends away from power output port 15 in a predetermined direction that is substantially parallel to the article of merchandise M. The second connector 25 of the power adapter cord 20 is then routed to the power input port P provided on the article of merchandise M. Depending on the orientation of the directional power input port P, the connector bobbin 40 is rotated relative to the integral front housing 36 and rear housing 38 by grasping and turning the connector element 42 secured to the rotatable bobbin to the extent necessary to align the connector element 42 with the corresponding connector element at the power input port P. The second connector 25 at the second end 24 of the power adapter cord 20 is then inserted into the power input port P of the article of merchandise M. In this manner, the cable assembly 30 of the power adapter cord 20 is not bent, kinked or twisted excessively, and does not obscure the operating surface OS of the merchandise from view or otherwise interfere with the ability of a potential purchaser to examine and/or operate the article of merchandise.

The foregoing has described one or more exemplary embodiments of a power adapter cord configured for electrical connection with an electronic article of merchandise to be displayed on a merchandise display device, such as a merchandise display stand. The power adapter cord includes a first connector at a first end and a rotatable second connector at a second end so that the second connector can be electrically connected to a directional (i.e. asymmetrical) power input port provided on the article of merchandise in different orientations. As a result, the power adapter cord can be routed from the merchandise display device to the article of merchandise without the cable assembly, and consequently, the conductors of the power adapter cord being bent, kinked or twisted excessively, and without the cable assembly interfering with a potential purchaser's viewing and/or operating the article of merchandise. Exemplary embodiments of a power adapter cord according to the invention and a merchandise display device associated with the power adapter cord have been shown and described herein for purposes of illustrating and enabling the best mode of the invention. Those of ordinary skill in the art, however, will readily understand and appreciate that numerous variations and modifications of the invention may be made without departing from the spirit and scope of the invention. Accordingly, all such variations and modifications are intended to be encompassed by the appended claims.

That which is claimed is:

1. A power adapter cord for an article of merchandise, comprising:
a cable assembly having a first end and a second end and containing at least one conductor extending between the first end and the second end;
a first connector disposed at the first end of the cable assembly, the first connector configured for electrical connection with an external source of electrical power; and
a second connector rotatably disposed at the second end of the cable assembly, the second connector configured for electrical connection with the article of merchandise to provide electrical power from the external source of power to the article of merchandise.

2. A power adapter cord according to claim 1, wherein the second connector comprises a rotatable connector bobbin and a connector element secured to the connector bobbin.

3. A power adapter cord according to claim 1, wherein one or more helical coils are formed from at least a portion of the cable assembly to provide for elastic linear extension of the cable assembly from a static length.

4. A power adapter cord according to claim 1, wherein the first connector comprises a retaining lip to retain the first connector within a power output port provided on a merchandise display device.

5. A power adapter cord according to claim 4, wherein the retaining lip of the first connector engages a retaining groove provided on the merchandise display device to secure the first connector on the merchandise display device.

6. A power adapter cord according to claim 1, wherein the second connector comprises a front housing and a rear housing defining an internal compartment that houses a rotatable connector bobbin and wherein a connector element is secured to the connector bobbin such that the connector bobbin and the connector element are rotatable relative to the front housing and the rear housing.

7. A power adapter cord according to claim 6, wherein a printed circuit board (PCB) is secured to the connector element and electrically connected to the at least one conductor of the cable assembly.

8. A power adapter cord according to claim 1, wherein the second connector comprises a micro-USB plug.

9. A power adapter cord according to claim 1, wherein the first connector comprises a barrel style connector element.

10. A merchandise display device for displaying and powering an electronic article of merchandise displayed on the merchandise display device, comprising:
a power adapter cord configured for electrically connecting a power output port provided on the merchandise display device with a directional power input port provided on the article of merchandise, the power adapter cord comprising a first connector at a first end for electrical connection to the power output port and a rotatable second connector at a second end for electrical connection to the power input port in different orientations.

11. A merchandise display device according to claim 10, wherein the power adapter cord comprises a cable assembly containing at least one conductor for conducting an electrical power signal and wherein the second connector comprises a rotatable connector element for electrically connecting to a directional connector element at the power input port provided on the article of merchandise.

12. A merchandise display device according to claim 11, wherein the second connector comprises a housing defining an internal compartment and a rotatable connector bobbin disposed within the internal compartment.

13. A merchandise display device according to claim 12, wherein the rotatable connector element is secured to the rotatable connector bobbin such that the connector bobbin and the connector element are rotatable together relative to the housing.

14. A merchandise display device according to claim 13, wherein the second connector further comprises a printed circuit board (PCB) that is mechanically secured to the connector element and is electrically connected between the connector element and the at least one conductor of the cable assembly.

15. A merchandise display device according to claim 11, wherein one or more helical coils are formed from at least a portion of the cable assembly to provide for elastic linear extension of the cable assembly from a static length and for biasing the cable assembly to the static length.

16. A merchandise display device according to claim 10, wherein the first connector comprises a retaining lip to retain the first connector within the power output port provided on the merchandise display device.

17. A merchandise display device according to claim 16, wherein the retaining lip of the first connector engages a retaining groove at the power output port provided on the merchandise display device to secure the first connector on the merchandise display device.

18. A merchandise display device according to claim 10, wherein the second connector comprises a micro-USB plug.

19. A merchandise display device according to claim 10, wherein the first connector comprises a barrel style connector element.
